(19) United States
(12) Patent Application Publication
(10) Pub. No.: US 2013/0049460 A1
(43) Pub. Date: Feb. 28, 2013

(54) METHOD FOR PREVENTING OVERVOLTAGES IN AN ELECTRICAL SYSTEM OF A MOTOR VEHICLE

(71) Applicants: Ralf HERBIG, Leonberg (DE); Herbert LABITZKE, Markgroeningen (DE)

(72) Inventors: Ralf HERBIG, Leonberg (DE); Herbert LABITZKE, Markgroeningen (DE)

(21) Appl. No.: 13/571,446

(22) Filed: Aug. 10, 2012

(30) Foreign Application Priority Data
Aug. 12, 2011 (DE) 10 2011 080 926.0

(51) Int. Cl. B60R 16/02

(52) U.S. Cl. 307/10.1

(57) ABSTRACT

A method for preventing overvoltages in an electrical system of a motor vehicle is provided. The electrical system has as voltages sources an electric machine coupled to an internal combustion engine and a motor vehicle battery. The electric machine has a stator winding, a rotor winding and a field regulator assigned to the rotor winding for controlling a field current flowing through the rotor winding. The voltage generated by the electric machine is limited to an upper voltage threshold value if (i) a rotational speed corresponding to the rotational speed of the electric machine is below a rotational speed threshold value, and (ii) a temperature corresponding to the temperature of the motor vehicle battery is below a temperature threshold value.

### BACKGROUND OF THE INVENTION

1. Field of the Invention

The present invention relates to a method and a control unit for preventing overvoltages in an electrical system of a motor vehicle.

2. Description of the Related Art

Claw pole generators having electrical excitation are often used as electric machines (generators, dynamos) in motor vehicles. The current flowing through the rotor winding functions as a manipulated variable for regulating the desired output voltage and is preset by an assigned field regulator. The regulation prevents, for example, greatly fluctuating voltage values, which could possibly damage downstream electrical equipment, from being supplied by the generator due to the very different engine rotational speeds. The field regulator today is usually part of a so-called generator regulator (for example, the applicant's multifunction regulator (MFR)), which also executes further regulating functions in addition to voltage regulation.

The control rate is limited by the relatively high time constant of the rotor winding. With rapid increases in the rotational speed, it may therefore occur that the field current cannot be reduced fast enough, so that overvoltages occur in the vehicle electrical system, which may result in damages or failure of electrical vehicle components. This problem is manifested in particular when throttle tip-ins are delivered in the disengaged state, to rev up the internal combustion engine because the field current is set very high in the range close to idling, to supply the necessary output voltage at the low rotational speed. If the rotational speed is increased rapidly, the field current cannot be reduced rapidly accordingly, so that the voltage rises suddenly.

It is therefore desirable to provide an approach to prevent overvoltages in the electrical system of a motor vehicle.

### BRIEF SUMMARY OF THE INVENTION

It has been recognized that overvoltages in an electrical system of a motor vehicle may be reduced or prevented entirely if the generator output voltage is limited at low rotational speeds and temperatures in particular. At low rotational speeds, the relative changes in rotational speed are very great, for example, when the internal combustion engine is revved up through throttle tip-ins in the disengaged state, starting from the idle speed. If low temperatures are additionally prevailing, the motor vehicle battery is not able to absorb an overvoltage.

Published German patent application document DE 44 40 830 A1 describes a method in which the field current is limited below a rotational speed threshold value. However, this method is not related to the present invention because it is used to reduce the resistance to be overcome by a starter and to prevent overvoltages.

Published German patent application document DE 41 02 335 A1 describes a method in which the field current is reduced when a temperature threshold value is exceeded, but not when the temperature is below this threshold value, as in the present case. This method is also not related to the present invention because it seeks to prevent overheating of the generator, not to prevent an overvoltage in the vehicle electrical system.

A rotational speed corresponding to the rotational speed of the electric machine is in particular the generator rotational speed itself, but also the rotational speed of the internal combustion engine (in particular the rotational speed of the crankshaft). For example, there is a gear ratio of approximately 2-3 between the crank shaft rotational speed and the generator rotational speed. A low rotational speed occurs, for example, when the rotational speed of the generator corresponds at most to half of its nominal rotational speed. A low rotational speed also occurs, for example, when the internal combustion engine is idling.

With motor vehicle batteries, the definitive parameters for the capability for dynamic current input include battery capacity, temperature, charging voltage, type of battery (AGM or lead battery) and state of aging (loss of active mass). At cold temperatures, batteries are usually able to consume only low currents. At higher temperatures, the current input capability of the battery is normally sufficient to prevent overvoltages. In addition to the temperature, the other parameters mentioned above may also be taken into account.

A temperature corresponding to the temperature of the motor vehicle battery is in particular the battery temperature per se, but also the cooling water temperature, ambient temperature or generator regulator temperature (for example, the IC chip temperature is measured in many generator regulators). A suitable temperature threshold value advantageously corresponds to a battery temperature of 5° C. at most.

In many cases, the present invention is implementable in a particularly simple manner through improved triggering of the generator without necessitating any design changes. Subsequent implementation in existing systems is therefore often possible, in particular when the limitation of the output voltage is preset by a control unit of the motor vehicle, e.g., by a so-called engine control unit or a charge management control unit, in particular because a rotational speed value and a temperature value are usually also present, e.g., the rotational speed of the internal combustion engine, and a cooling water temperature and an ambient temperature.

The functionality of the field regulator is adapted to the dynamics of the internal combustion engine. Driving safety is increased because overvoltage damages and failure of electrical vehicle components are prevented.

The voltage generated by the electric machine may advantageously be limited to an upper voltage threshold value in that the field regulator limits the field current to an upper field current threshold. In this case, a higher setpoint voltage which the field regulator does not convert may, by all means, be predefined externally. A possible field current threshold value is, for example, at most half of the maximum possible or allowed field current.

The output voltage is advantageously limited in such a way that the upper setpoint voltage value corresponds at most to the value of the instantaneous vehicle electrical system voltage. The instantaneous vehicle electrical system voltage is determined essentially by the motor vehicle battery. Subsequently, essentially no power is output by the generator to the vehicle electrical system, so that little or no field current is generated.

The implementation of the method in the form of software is advantageous because this entails particularly low costs, in particular when an executing control unit is additionally used for other tasks and therefore is present anyway. Suitable data media for supplying the computer program include in particular diskettes, hard drives, flash memories, EEPROMs, CD-ROMs, DVDs, etc. It is also possible to download a program via computer networks (Internet, intranet, etc.).

### BRIEF DESCRIPTION OF THE DRAWING

FIG. 1 shows an example embodiment of an electric machine for illustrating the present invention.

### DETAILED DESCRIPTION OF THE INVENTION

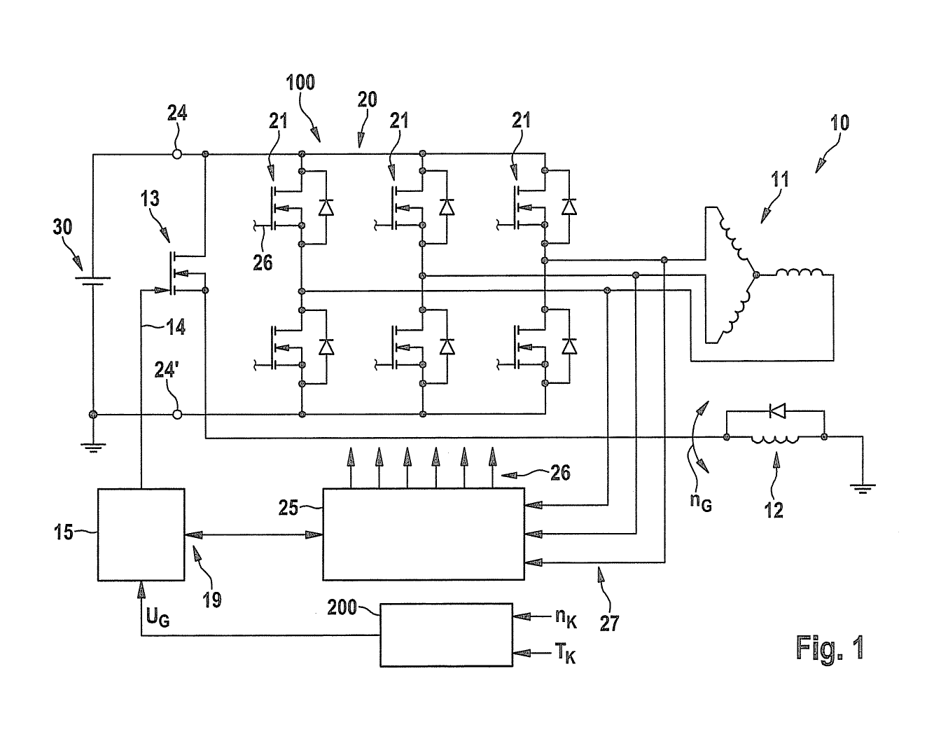

FIG. 1 shows an electric machine, such as that on which the present invention may be based, in a diagram labeled with reference numeral 100 on the whole. The electric machine has a generator component 10 and a power converter component 20. The electric machine usually functions as a generator for supplying an electrical system of a motor vehicle. The power converter component is operated as a rectifier (e.g. as a synchronous rectifier) in the generator mode of the machine, and the electric machine, more precisely a rotor winding 12, is driven by an internal combustion engine of the motor vehicle. Rotor winding 12 is usually connected to a crankshaft of the internal combustion engine (not shown)—via a belt, for example. A crankshaft rotational speed is denoted as n_{K}, a machine rotational speed is denoted as n_{G}.

Generator component 10 is represented only schematically in the form of star-connected stator windings 11 and field winding or rotor winding 12, which is connected in parallel to a diode. The rotor winding is switched in a clocked manner by a power switch 13, which is connected to a terminal 24 of power converter component 20. Power switch 13 is triggered in accordance with field regulator 15, power switch 13, just as the diode connected in parallel to rotor winding 12, usually being integrated into an application-specific integrated circuit (ASIC) of the field regulator. Within the scope of the present patent application, a three-phase generator is shown. In principle, however, the present invention may also be used with generators having more or fewer phases, for example, five-phase generators.

Power converter component 20 is designed here as a B6 circuit and has switch elements 21, which may be designed as MOSFETs 21. MOSFETs 21 are connected to corresponding stator windings 11 of the generator, for example, via busbars. Furthermore, the MOSFETs are connected to terminals 24, 24′ and supply a d.c. current for the electrical system, including battery 30, of the motor vehicle, with appropriate triggering in the generator mode of the electric machine. Switch elements 21 are triggered by a trigger device 25 via trigger channels 26, not all of which are provided with reference numerals for reasons of clarity. Trigger device 25 receives the phase voltage of the individual stator windings via one or more phase channels 27. Additional devices may be provided to supply these phase voltages, although these are not shown for the sake of clarity. Likewise, a design using diodes instead of switch elements is also possible, so that triggering may be omitted.

Trigger device 25 carries out an evaluation of the phase voltages supplied via phase channels 27 in (synchronous) rectifier mode and determines from this a particular activation and deactivation time of a single MOSFET 21. Control via trigger channels 26 affects the gate terminals of MOSFET 21. For reasons of clarity, not all MOSFETs are provided with reference numeral 21 and not all trigger channels are provided with reference numeral 26.

Known field regulators, such as field regulator 15, which is provided in this specific embodiment, have a so-called V-clamp terminal 19, which is connected to one phase of the stator winding of the generator. The frequency of the V-clamp signal or of the phase input signal is evaluated in regulator 15 and functions to activate or deactivate the regulator operation as a function of the characteristic variables of this signal and ultimately to trigger power switch 13 via a trigger line 14. The phase signal for phase signal input 19 may also be passed through trigger device 25, as shown here. Field regulator 15 and trigger device 25 may also be integral parts of a generator regulator.

In the present example, the electric machine, which is field regulator 15 in the present example, is connected to a control unit 200 of the motor vehicle, for example, a so-called engine control unit or a charge control unit. Control unit 200 predefines a setpoint voltage value U_{G} for the generator output voltage between terminals 24 and 24′. The control unit knows the rotational speed of the internal combustion engine (crankshaft rotational speed) n_{K} and a cooling water temperature T_{K}.

A conventional gear ratio between the crankshaft of the internal combustion engine (not shown) and rotor winding 12 is in the range of 2-3. At a conventional idle speed n_{K} of approximately 550 min⁻¹ to 900 min⁻¹, rotational speed n_{G} of the electric machine is then between 1100 min⁻¹ and 2700 min⁻¹. For example, a rotational speed of the electric machine of approximately 3000 min⁻¹ may be predefined as the rotational speed threshold value. If, as in the example shown here, crankshaft rotational speed n_{K} is monitored as a rotational speed corresponding to rotational speed n_{G} of electric machine 100, then the rotational speed threshold value for the crankshaft rotational speed is determined via the known gear ratio.

In the disengaged state, for example, when the vehicle is stationary, a relatively rapid and great increase in rotational speed, which cannot be compensated by field regulator 15 because of the high rotor time constants, may be induced by throttle tip-ins by the driver. If there is also a low cooling water temperature T_{K}, so that battery 30 is cold, for example, colder than 5° C., the current input capability of the battery is greatly limited and an overvoltage cannot be absorbed. Cooling water temperature T_{K} is monitored as a temperature corresponding to the temperature of motor vehicle battery 30 in the present example. It has been found that presetting a temperature threshold value of 5° C., for example, for the cooling water temperature is suitable for the present invention.

In such a case (i.e., rotational speed below the rotational speed threshold value and temperature below the temperature threshold value), the generator voltage between terminals 24 and 24′ is therefore limited within the scope of the present invention, in the present case by presetting an upper voltage threshold value as a reduced setpoint voltage by control unit 200. The upper voltage threshold value is advantageously set to a value from a range around the instantaneous vehicle electrical system voltage, for example to the instantaneous vehicle electrical system voltage. It is essential only that the value is selected in such a way that at most a minor field current (for example, 2 A at most) flows through rotor winding 12. The field current preferably amounts to half of a maximum allowed field current.

What is claimed is:

1. A method for preventing overvoltages in an electrical system of a motor vehicle, the electrical system having as voltage sources (i) an electric machine coupled to an internal combustion engine, and (ii) a motor vehicle battery, wherein the electric machine has a stator winding, a rotor winding and a field regulator assigned to the rotor winding for controlling a field current flowing through the rotor winding, the method comprising:
limiting the voltage generated by the electric machine to an upper voltage threshold value if a rotational speed corresponding to a rotational speed of the electric machine is below a predefined rotational speed threshold value and a temperature corresponding to a temperature of the motor vehicle battery is below a predefined temperature threshold value.

2. The method as recited in claim 1, wherein the voltage generated by the electric machine is limited to the upper voltage threshold value by predefining a setpoint voltage value which does not exceed the upper voltage threshold value.

3. The method as recited in claim 2, wherein the setpoint voltage value is predefined by an engine control unit.

4. The method as recited in claim 1, wherein the voltage generated by the electric machine is limited to the upper voltage threshold value by limiting the field current to a predefined upper field current threshold value.

5. The method as recited in claim 4, wherein the field current is limited by the field regulator.

6. The method as recited in claim 4, wherein the upper field current threshold value corresponds to half of a maximum allowed field current.

7. The method as recited in claim 2, wherein the upper voltage threshold value corresponds to the value of the instantaneous vehicle electrical system voltage.

8. The method as recited in claim 2, wherein the upper voltage threshold value corresponds to the value of the instantaneous battery voltage.

9. The method as recited in claim 2, wherein the upper temperature threshold value corresponds to a temperature of the motor vehicle battery of at most 5° C.

10. The method as recited in claim 2, wherein the rotational speed threshold value does not exceed half the nominal rotational speed of the electric machine.

11. The method as recited in claim 2, wherein the rotational speed threshold value corresponds to an idle speed of the internal combustion engine.

12. A control unit for preventing overvoltages in an electrical system of a motor vehicle, the electrical system having as voltage sources (i) an electric machine coupled to an internal combustion engine, and (ii) a motor vehicle battery, wherein the electric machine has a stator winding, a rotor winding and a field regulator assigned to the rotor winding for controlling a field current flowing through the rotor winding, the control unit comprising:
means for limiting the voltage generated by the electric machine to an upper voltage threshold value if a rotational speed corresponding to a rotational speed of the electric machine is below a predefined rotational speed threshold value and a temperature corresponding to a temperature of the motor vehicle battery is below a predefined temperature threshold value.
